(19) United States
(12) Patent Application Publication
(10) Pub. No.: US 2015/0278087 A1
(43) Pub. Date: Oct. 1, 2015

(54) STORAGE DEVICE AND AN OPERATING METHOD OF THE STORAGE DEVICE

(71) Applicants: ILSU HAN, Incheon (KR); HeeChang Cho, Seoul (KR)

(72) Inventors: ILSU HAN, Incheon (KR); HeeChang Cho, Seoul (KR)

(21) Appl. No.: 14/541,335

(22) Filed: Nov. 14, 2014

(30) Foreign Application Priority Data
Mar. 26, 2014 (KR) 10-2014-0035144

(51) Int. Cl. G06F 12/02

(52) U.S. Cl. CPC G06F 12/0246; G06F 2212/7206; G06F 2212/7202

(57) ABSTRACT

An operation method of a storage device includes receiving a request; performing an operation corresponding to the received request; generating response data corresponding to the performed operation wherein the response data includes information on the performed operation; and outputting the response data. Status information is added to and output with the response data, wherein the status information includes information on a status of the storage device.

### CROSS-REFERENCE TO RELATED APPLICATION

This application claims priority under 35 U.S.C. §119 to Korean Patent Application No. 10-2014-0035144 filed Mar. 26, 2014, in the Korean Intellectual Property Office, the disclosure of which is incorporated by reference herein in its entirety.

### TECHNICAL FIELD

The inventive concept described herein relates to a storage device and an operation method thereof.

### DISCUSSION OF RELATED ART

A storage device may store data according to a control of a host device, such as a computer, a smart phone, or a tablet. The storage device may include a device for storing data on a magnetic disk, such as a hard disk drive, or a semiconductor memory, such as a solid state drive or a memory card. The semiconductor memory may be a nonvolatile memory.

Nonvolatile memories may include a read only memory (ROM), a programmable ROM (PROM), an electrically programmable ROM (EPROM), an electrically erasable and programmable ROM (EEPROM), a flash memory, a phase-change random access memory (PRAM), a magnetic RAM (MRAM), a resistive RAM (RRAM), a ferroelectric RAM (FeRAM), etc.

An operation speed of the host device that communicates with the storage device may be increased due to improvements in semiconductor fabricating technology. Accordingly, the size of contents that the storage device or the host device of the storage device utilizes may be increased.

### SUMMARY

An exemplary embodiment of the inventive concept provides an operation method of a storage device which includes a nonvolatile memory and a memory controller configured to control the nonvolatile memory, the operation method comprising receiving a request; performing an operation corresponding to the received request; generating response data corresponding to the performed operation, wherein the response data includes information on the performed operation; and outputting the response data, wherein status information is added to and output with the response data, wherein the status information includes information on a status of the storage device.

In an exemplary embodiment of the inventive concept, collection of the status information is independent of the received request and the performed operation.

In an exemplary embodiment of the inventive concept, the response data and the status information are transferred using a format of Universal Flash Storage Protocol Information Unit (UPIU).

In an exemplary embodiment of the inventive concept, the status information is transferred using at least one field of 16^{th} to 31^{st} fields of a response UPIU.

In an exemplary embodiment of the inventive concept, the status information is transferred using at least one field of 4^{th} to 7^{th}, 9^{th}, and 20^{th} to 31^{st} fields of a data out UPIU format.

In an exemplary embodiment of the inventive concept, the status information is transferred using at least one field of 20^{th} to 31^{st} fields of a ready to transfer UPIU.

In an exemplary embodiment of the inventive concept, the status information is transferred using at least one field of 20^{th} to 31^{st} fields of a task management response UPIU.

In an exemplary embodiment of the inventive concept, the status information is transferred using at least one field of 28^{th} to 31^{st} fields of a query response UPIU.

In an exemplary embodiment of the inventive concept, the status information is transferred using at least one field of 16^{th}, 17^{th}, and 20^{th} to 27^{th} fields of a query response UPIU.

In an exemplary embodiment of the inventive concept, the status information is transferred using at least one field of 16^{th} to 19^{th} and 24^{th} to 27^{th} fields of a query response UPIU.

In an exemplary embodiment of the inventive concept, the status information is transferred using at least one field of 16^{th} to 22^{nd} and 24^{th} to 27^{th} fields of a query response UPIU.

In an exemplary embodiment of the inventive concept, the status information is transferred using at least one field of 13^{th} to 27^{th} fields of a query response UPIU.

In an exemplary embodiment of the inventive concept, the status information is transferred using at least one field of 12^{th} to 31^{th} fields of a NOP IN UPIU.

In an exemplary embodiment of the inventive concept, the status information includes power-control information of the storage device.

In an exemplary embodiment of the inventive concept, the status information further includes information on a time when the storage device enters a power-saving mode.

An exemplary embodiment of the inventive concept provides a storage device comprising a nonvolatile memory; and a memory controller configured to control the nonvolatile memory, wherein the memory controller is further configured to collect status information including information on a status of the nonvolatile memory or the memory controller, and wherein if an access request is received from an external device, the memory controller is configured to perform the access request, add the status information to response data including an execution result of the access request to generate first data, and output the first data to the external device.

An exemplary embodiment of the inventive concept provides a computing system comprising a storage device; and a host device configured to transmit a request to the storage device to control the storage device, write data at the storage device or read data from the storage device, wherein the storage device is configured to collect status information including information on a status of the storage device, and wherein the storage device is further configured to receive the request, perform the received request, add the status information to response data including an execution result of the received request to generate first data, and output the first data to the host device.

In an exemplary embodiment of the inventive concept, the storage device is further configured to insert a first type of status information at a first location in a data format including the response data, and the host device is further configured to extract the first type of status information from the first location of the data format.

In an exemplary embodiment of the inventive concept, the storage device is further configured to insert the status information and flag information indicating a type of the status information in a data format including the response data, the host device is further configured to extract the status information using the flag information of the status information, and the flag information is inserted at a predetermined location in the data format.

In an exemplary embodiment of the inventive concept, the storage device is further configured to insert the status information and map information indicating a location and a type of the status information in a data format including the response data, the host device is further configured to extract the status information using the map information, and the map information is inserted at a predetermined location in the data format.

An exemplary embodiment of the inventive concept provides a method of operating a storage device collecting status information of the storage device; receiving a request to perform an operation with a memory of the storage device; performing the operation in response to the request and generating operation related data; accessing the status information and combining the status information with the operation related data; and outputting the combination of the status information and the operation related data in a first data format.

In an exemplary embodiment of the inventive concept, the collecting of the status information and the combining of the status information with the operation related data is performed in a controller of the storage device.

In an exemplary embodiment of the inventive concept, the first data format includes UPIU.

In an exemplary embodiment of the inventive concept, the memory includes a nonvolatile memory.

In an exemplary embodiment of the inventive concept, the status information is power related.

### BRIEF DESCRIPTION OF THE FIGURES

The above and other features of the inventive concept will become more apparent by describing exemplary embodiments thereof with reference to the accompanying figures, in which:

FIG. 1 is a block diagram illustrating a storage device according to an exemplary embodiment of the inventive concept;

FIG. 2 is a flow chart illustrating an operation method of a storage device according to an exemplary embodiment of the inventive concept;

FIG. 3 shows a format of data that a storage device outputs, according to an exemplary embodiment of the inventive concept;

FIGS. 4 to 6 show exemplary embodiments of the inventive concept in which status information is included in data output from a storage device;

FIG. 7 shows a format of data that a storage device outputs, according to an exemplary embodiment of the inventive concept;

FIG. 8 shows a format of data that a storage device outputs, according to an exemplary embodiment of the inventive concept;

FIG. 9 shows a format of data that a storage device outputs, according to an exemplary embodiment of the inventive concept;

FIG. 10 shows a format of data that a storage device outputs, according to an exemplary embodiment of the inventive concept;

FIGS. 11 to 19 show 12th to 27th fields shown in FIG. 10, according to exemplary embodiments of the inventive concept;

FIG. 20 shows a format of data that a storage device outputs, according to an exemplary embodiment of the inventive concept;

FIG. 21 is a block diagram illustrating a memory controller according to an exemplary embodiment of the inventive concept;

FIG. 22 is a block diagram illustrating a nonvolatile memory according to an exemplary embodiment of the inventive concept;

FIG. 23 is a circuit diagram illustrating a memory block according to an exemplary embodiment of the inventive concept;

FIG. 24 is a circuit diagram illustrating a memory block according to an exemplary embodiment of the inventive concept;

FIG. 25 is a block diagram illustrating a storage device according to an exemplary embodiment of the inventive concept; and

FIG. 26 is a block diagram illustrating a computing device according to an exemplary embodiment of the inventive concept.

### DETAILED DESCRIPTION OF THE EMBODIMENTS

Exemplary embodiments of the inventive concept will be described in detail with reference to the accompanying drawings. The inventive concept, however, may be embodied in various different forms, and should not be construed as being limited only to the illustrated embodiments. Unless otherwise noted, like reference numerals denote like elements throughout the attached drawings and written description, and thus descriptions will not be repeated. In the drawings, the sizes and relative sizes of layers and regions may be exaggerated for clarity.

As used herein, the singular forms “a”, “an” and “the” are intended to include the plural forms as well, unless the context clearly indicates otherwise.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present.

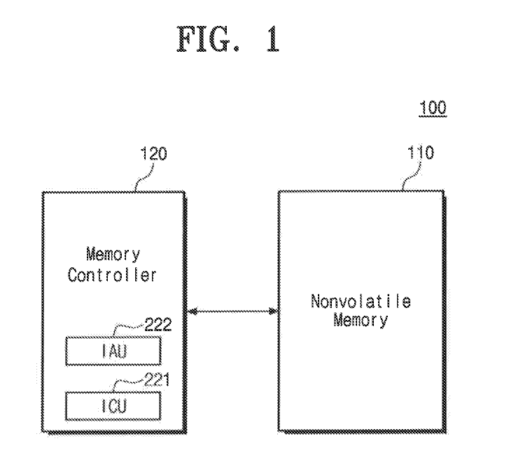

FIG. 1 is a block diagram illustrating a storage device 100 according to an exemplary embodiment of the inventive concept. Referring to FIG. 1, the storage device 100 contains a nonvolatile memory 110 and a memory controller 120. The storage device 100 may be a solid state drive, a memory card, or an embedded memory.

The nonvolatile memory 110 performs read, write, and erase operations according to a control of the memory controller 120. The nonvolatile memory 110 may include a flash memory. However, the inventive concept is not limited thereto. For example, the nonvolatile memory 110 may include at least one of nonvolatile memories, such as Phase-change random access memory (PRAM), Magnetic RAM (MRAM), Resistive RAM (RRAM), Ferroelectric RAM (FeRAM), and so on.

The memory controller 120 is configured for controlling the nonvolatile memory 110 according to a request of a host device (not shown) or according to a predetermined schedule. For example, the memory controller 120 controls the nonvolatile memory 110 to perform a read, a write, or an erase operation. The memory controller 120 informs the host device 100 of a degree of write-progression of write requests.

The memory controller 120 contains an information collection unit 221 and an information addition unit 222. The information collection unit 221 may collect information on a status of the storage device 100 periodically or continuously.

For example, the information collection unit 221 collects information on a power of the storage device 100. In the storage device 100, the information collection unit 221 may collect, as status information, at least one of power consumption of the storage device 100, expected power consumption of the storage device 100, information indicating whether a current mode of the storage device 100 is a power-saving mode or a wake-up mode, information of a time when the storage device 100 enters the power-saving mode, and information of a time when the storage device 100 enters the wake-up mode.

For example, the information collection unit 221 may collect information on a life time (or, expected life time) of the storage device 100 as the status information.

For example, the information collection unit 221 may collect a message that the storage device 100 needs to send to a host device (not shown) for accessing the storage device 100. For example, the information collection unit 221 may collect, as the status information, a message for requesting control of a channel used to communicate with the storage device 100 in a power-saving mode, a message for requesting a status check of the storage device 100, and so on.

For example, the memory controller 120 stores a variety of information, which is necessary to control the storage device 100, in registers. The information collection unit 221 may associate the registers with particular status information of the memory controller 120.

For example, the information collection unit 221 may include a collection module configured to collect status information of the storage device 100 actively and registers configured to store the collected status information.

The information addition unit 222 adds status information collected by the information collection unit 221 to data that the memory controller 120 outputs to an external host device. For example, the memory controller 120 may receive a variety of requests from the external host device. Based on the input requests, the memory controller 120 performs operations corresponding to the input requests. Executing the operations corresponding to the input requests, the memory controller 120 provides the external host device with data (e.g., response data) including information on the results of the executed operations. The memory controller 120 adds the status information to data to be provided to the external host device.

In an exemplary embodiment of the inventive concept, at least one of the information collection unit 221 and information addition unit 222 may be implemented with software, hardware, or a combination of hardware and software.

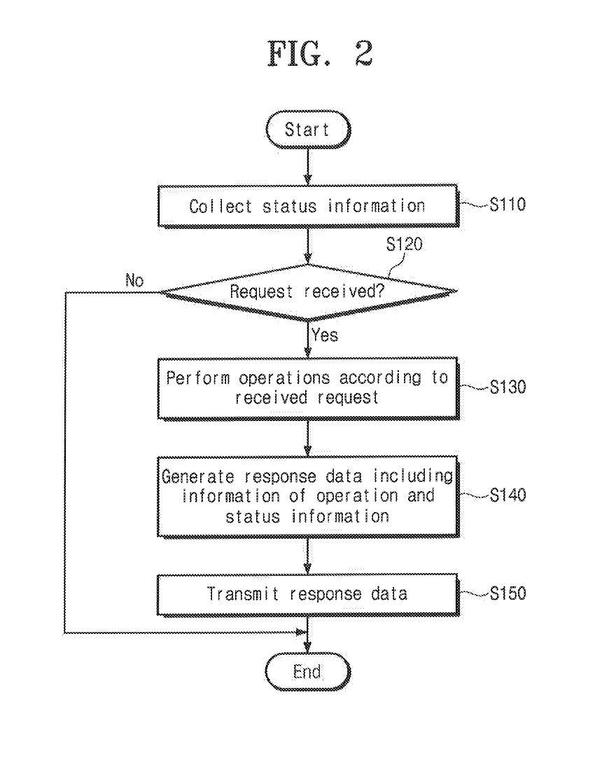

FIG. 2 is a flow chart illustrating an operation method of the storage device 100 according to an exemplary embodiment of the inventive concept. Referring to FIGS. 1 and 2, in step S110, status information is collected. For example, the information collection unit 221 may collect status information periodically, continuously, or when status information is changed.

In step S120, whether a request is received is determined. If a request is not received from an external host device (not shown), the storage device 100 may not perform an operation using status information. If a request is received from the external host device, the method proceeds to step S130.

In step S130, the storage device 100 performs an operation according to the input request. In step S140, the storage device 100 generates response data including operation information and status information. For example, the storage device 100 may produce response data that contains information indicating an operation-executed result and status information.

In step S150, the memory controller 120 provides the external host device with the response data including the operation information and the status information.

In an exemplary embodiment of the inventive concept, a request from the external host device may contain a request for writing data at the storage device 100, a request for reading data from the storage device 100, a request for erasing data in the storage device 100, a request for controlling the storage device 100, and so on. A request from the external host device may be one of requests defined by the communication standard between the storage device 120 and the external host device. The request does not have to include a request for status information, in fact it may not. In other words, the storage device 100 receives normal requests from the external host device and executes operations according to the normal requests. The storage device 100 provides the external host device with normal response data indicating operation-executed results. In particular, the storage device 100 may transmit status information additionally.

The operation S110 of collecting status information is described as it is executed before a request is received from the external host device. However, the inventive concept is not limited thereto. For example, the operation S110 of collecting status information may be executed after a request is received from the external host device.

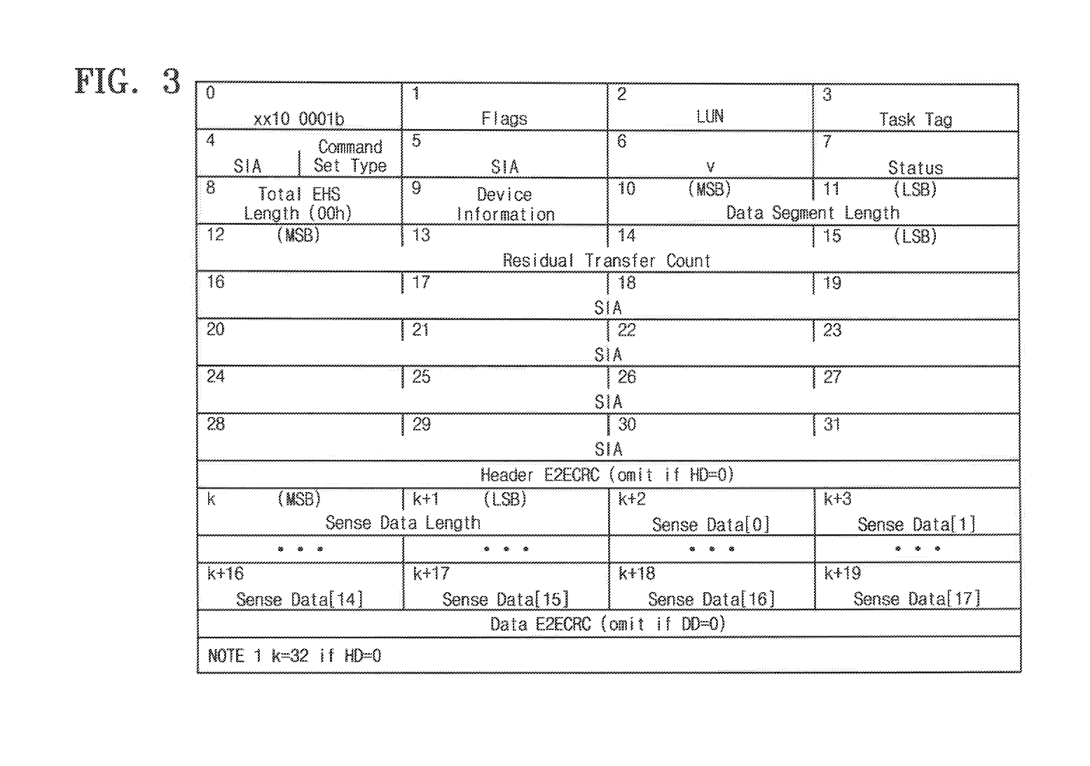

FIG. 3 shows a format of data that the storage device 100 outputs, according to an exemplary embodiment of the inventive concept. In an exemplary embodiment of the inventive concept, the storage device 100 may output data according to a format of Universal Flash Storage Protocol Information Unit (UPIU) defined by the Universal Flash Storage (UFS) specification.

Referring to FIG. 3, the storage device 100 outputs a response UPIU. The response UPIU is formed of a plurality of fields. Each field of the response UPIU is referred to using a number marked in a box. Each field of the response UPIU includes 1-byte data.

A 0^{th} field of the response UPIU includes information on a transaction type. For example, a transaction code assigned to the response UPIU is ‘100001b’. A 1^{st} field of the response UPIU contains information on a flag. The 1^{st} field may store a data overflow flag indicating that the amount of data the storage device 100 will send is greater than that of data an external host device requests, a data underflow flag indicating that the amount of data the storage device 100 will send is smaller than that of data the external host device requests, a flag indicating that a buffer offset or a transfer count of requested data is abnormal, and so on. A 2^{nd} field of the response UPIU stores information on a logical unit number (LUN) of a target device, and a 3^{rd} field of the response UPIU includes information on a task tag.

A part (e.g., four bits) of a 4^{th} field of the response UPIU is used as a status information area SIA, and the rest (e.g., four bits) of the 4^{th} field contains information on a command set type. For example, the command set type may include a small computer system interface (SCSI) command set, a UFS specific command set, a vendor specific command set, and so on. A 5^{th} field of the response UPIU is used as a status information area SIA. A 6^{th} field of the response UPIU is a response field (denoted as ‘v’). The 6^{th} field may include information indicating whether an operation corresponding to a request received from the external host device succeeds or fails. A 7^{th} field of the response UPIU stores information on an SCSI status according to the SCSI command set.

An 8^{th} field of the response UPIU includes a total length of an Extra Header Segment (EHS). A 9^{th} field of the response UPIU stores device information. 10^{th} and 11^{th} fields of the response UPIU contain information on the number of valid bytes of a data segment. For example, the 10^{th} field includes a most significant bit (MSB) thereof, and the 11^{th} field includes a least significant bit (LSB) thereof.

12^{th} to 15^{th} fields of the response UPIU may include the number of bytes that the storage device 100 does not send when a data overflow occurs, the number of bytes that the storage device 100 does not send when a data underflow occurs, and so on. For example, a residual data transfer count may be found in the 12^{th} to 15^{th} fields.

16^{th} to 31^{st} fields of the response UPIU are used as status information areas SIA.

An end-to-end Cyclic Redundancy Check (CRC) code of a header (shown as Header E2ECRC in FIG. 3 and many of the following figures) is optionally added following the 31^{st} field of the response UPIU. For example, if a first bit of the 0^{th} field is ‘0’, the end-to-end CRC code of the data may be omitted (shown as HD=0 in FIG. 3 and many of the following figures). In this case, a k^{th} field of the response UPIU may be a 32^{nd} field following the 31^{st} field.

The k^{th} field of the response UPIU stores information on lengths of sense data fields. (k+1)^{th} to (k+19)^{th} fields of the response UPIU are sense data fields and contain additional information on an error status.

An end-to-end CRC code of data (shown as Data E2ECRC in FIG. 3 and many of the following figures) is optionally added following the (k+19)^{th} field of the response UPIU. For example, if a second bit of the 0^{th} field is ‘0’, the end-to-end CRC code of data may be omitted (shown as DD=0 in FIG. 3 and many of the following figures).

A part of the 4^{th} field, the 5^{th} field, and the 16^{th} to 31^{st} fields of the response UPIU are used as a status information area SIA. Status information may be added as at least one field or at least one bit of the status information area SIA.

In the case status information is added to another field besides the status information area SIA, data that is to be sent from the storage device 100 to an external host device may be damaged by the status information. Thus, since the status information is added as at least one field or at least one bit of the status information area SIA in fields other than those already including data, the status information may be sent to the external host device together with a result of an operation that the storage device 100 has performed. This use of the status information can increase operation performance of the storage device 100. For example, this information can be utilized by the host device to determine how to control the storage device.

In an exemplary embodiment of the inventive concept, the two or more status information may be included in a predetermined location (e.g., a field or a bit) of the status information area SIA according to respective information types. Locations of the two or more status information according to types of the two or more status information may be in common to the storage device 100 and the external host. A host device receiving a response UPIU may extract the two or more status information from a predetermined location of the status information area SIA.

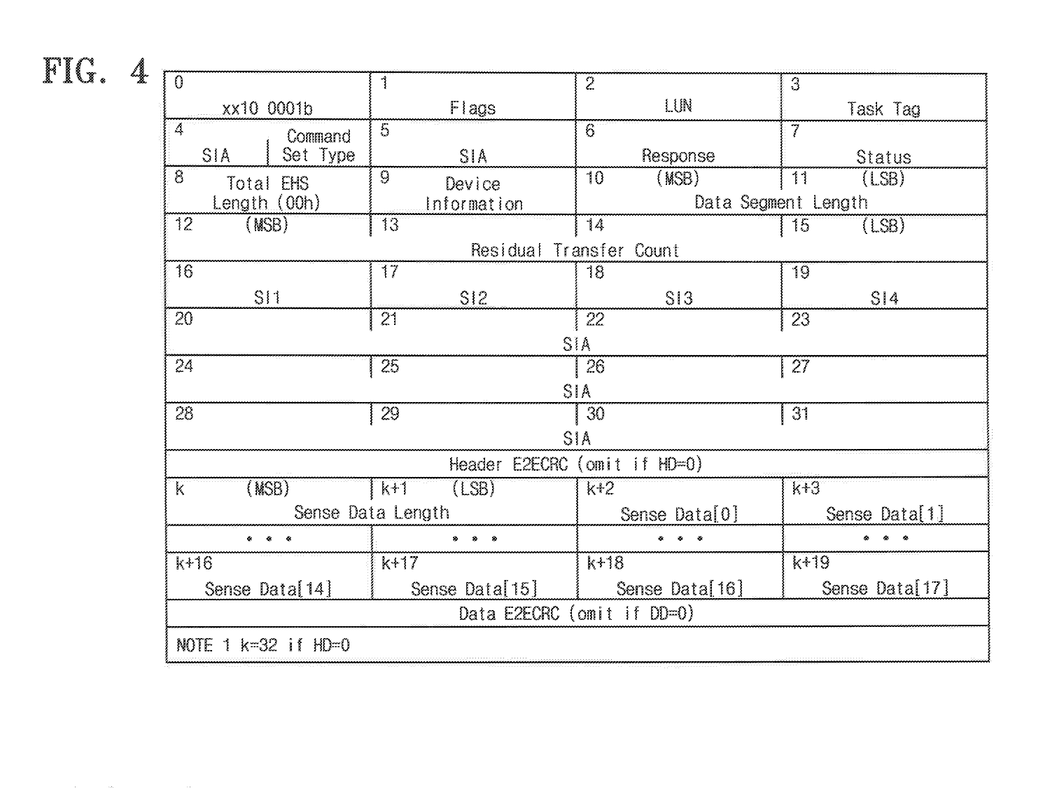

For example, as illustrated in FIG. 4, first status information SI1 may be included in a 16^{th} field of the response UPIU, and second status information SI2 may be included in a 17^{th} field of the response UPIU. Third status information SI3 may be included in an 18^{th} field of the response UPIU, and fourth status information SI4 may be included in a 19^{th} field of the response UPIU. In the case the storage device 100 provides the second status information SI2, it adds the second status information SI2 to the 17^{th} field. In the case the storage device 100 does not provide the second status information SI2, it may empty the 17^{th} field.

In an exemplary embodiment of the inventive concept, the two or more status information may be included in the status information area SIA. The two or more status information may be provided together with flag data indicating respective information type. In this case, locations of the two or more information are not determined according to the types of the two or more status information, and locations of the flag data are predetermined. For example, a first bit of each field of the status information area SIA is set to include flag data, and remaining bits of the status information area SIA may be set to include status information associated with the flag data. The external host device may extract the status information based on the flag data.

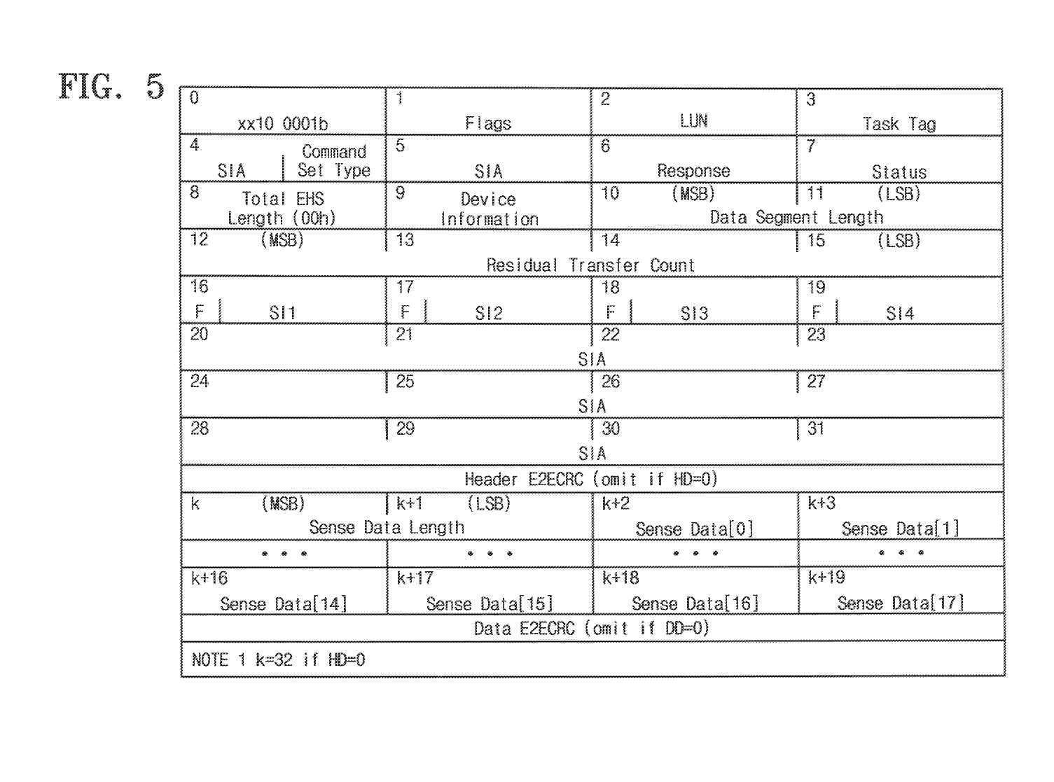

For example, as illustrated in FIG. 5, 16^{th} to 19^{th} fields of the response UPIU may be set to include status information. At least a first bit of each of the 16^{th} to 19^{th} fields may be set to include flag data F. Remaining bits of each of the 16^{th} to 19^{th} fields may be set to include status information SI1 to SI4.

In the event that the storage device 100 is configured to provide first and second status information SI1 and SI2, it adds flag data F indicating a type of the first status information SI1 to at least the first bit of the 16^{th} field and the first status information SI1 to the remaining bits of the 16^{th} field. The storage device 100 adds flag data F indicating a type of the second status information SI2 to at least the first bit of the 17^{th} field and the second status information SI2 to the remaining bits of the 17^{th} field.

In the event that the storage device 100 is configured to provide third and fourth status information SI3 and SI4, it adds flag data F indicating a type of the third status information SI1 to at least the first bit of the 18^{th} field and the third status information SI3 to the remaining bits of the 18^{th} field. The storage device 100 adds flag data F indicating a type of the fourth status information SI4 to at least the first bit of the 19^{th} field and the fourth status information SI4 to the remaining bits of the 19^{th} field.

As another example, two or more status information may be included in the status information area SIA. The two or more status information may be provided together with status information map data indicating types of the two or more status information and locations where the two or more status information is stored. In this case, a size and a location of the status information map data may be predetermined. Sizes and locations of the two or more status information may not be limited. The external host device may extract the two or more status information using the status information map data.

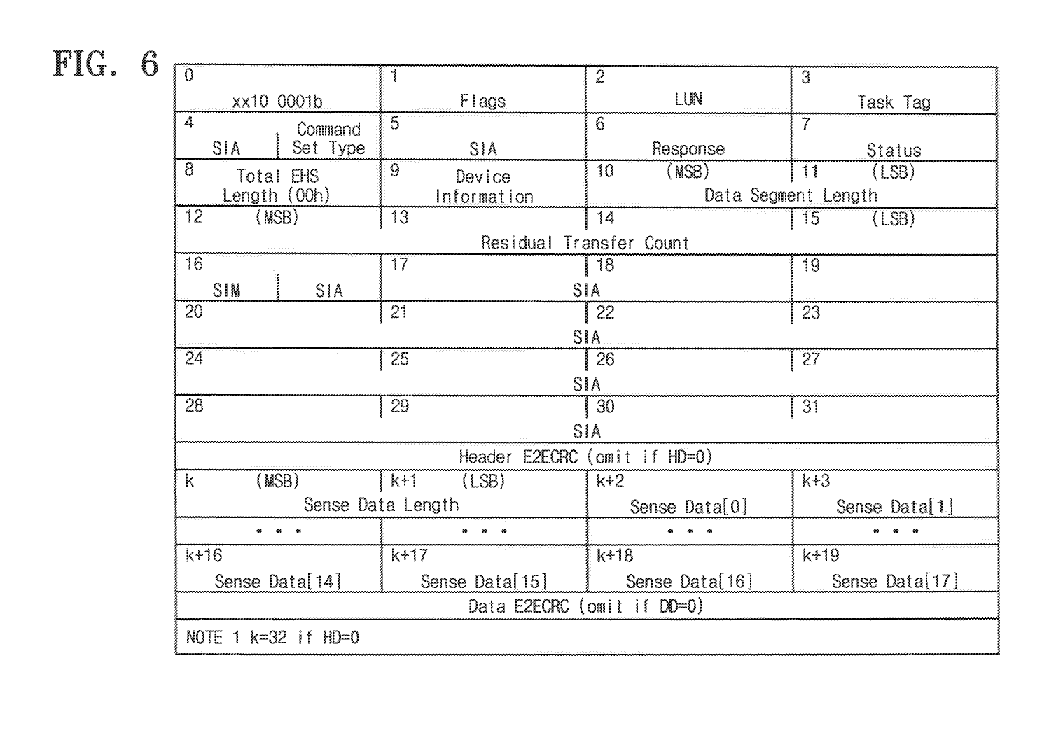

For example, as illustrated in FIG. 6, 16^{th} to 19^{th} fields of the response UPIU may be set to include status information. Status information map data SIM may be included in some bits of the 16^{th} field. Status information SIA corresponding to the status information map data SIM may be included in the remaining bits of the 16^{th} field and 17^{th} to 19^{th} fields.

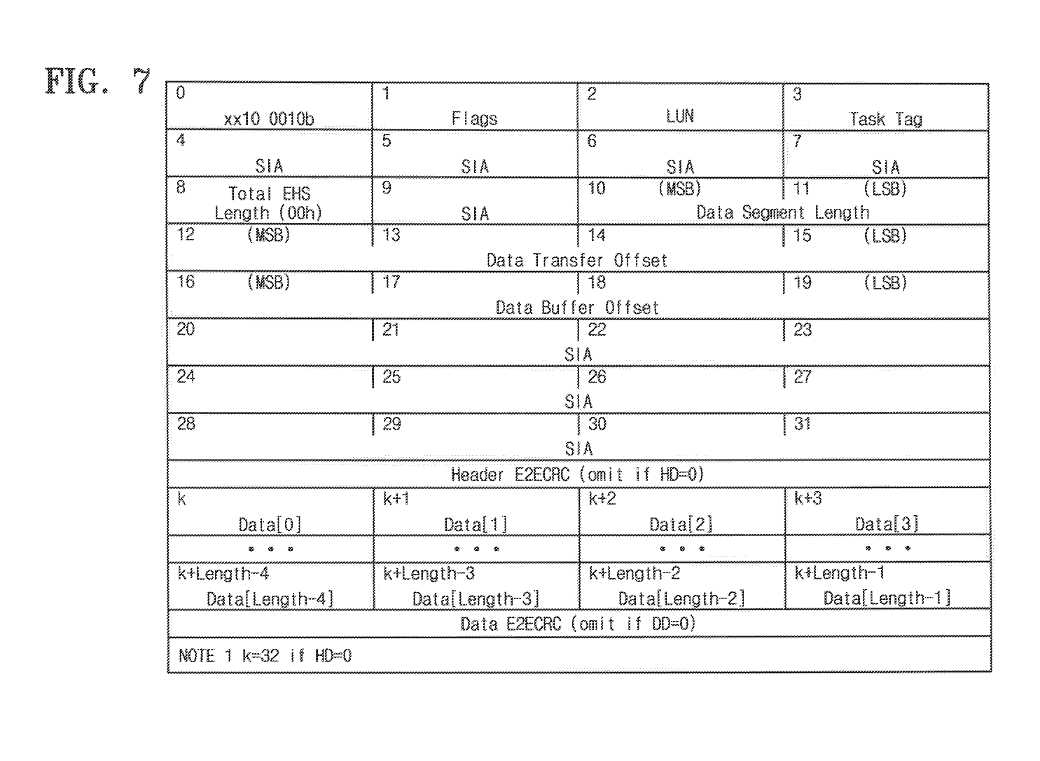

FIG. 7 shows a format of data that the storage device 100 outputs, according to an exemplary embodiment of the inventive concept. In an exemplary embodiment of the inventive concept, the storage device 100 may output data according to a format of UPIU according to the UFS specification.

Referring to FIG. 7, the storage device 100 outputs a data out UPIU. The data out UPIU is formed of a plurality of fields. Each field of the data out UPIU is referred to using a number marked in a box. Each field of the data out UPIU includes 1-byte data.

A 0^{th} field of the data out UPIU includes information on a transaction type. For example, a transaction code assigned to the data out UPIU is ‘100010b’. A 1^{st} field of the data out UPIU is a flag field and is not used in a data out UPIU. A 2^{nd} field of the data out UPIU stores information on a LUN of a target device, and a 3^{rd} field of the data out UPIU includes information on a task tag.

4^{th} to 7^{th} fields of the data out UPIU may be used as a status information area SIA.

An 8^{th} field of the data out UPIU includes a total length of an EHS. A 9^{th} field of the data out UPIU is used as a status information area SIA. 10^{th} and 11^{th} fields of the data out UPIU contain information on the number of valid bytes of a data segment.

12^{th} to 15^{th} fields of the data out UPIU may include information on an offset of data, included in a corresponding UPIU, from among all data to be transmitted. In other words, a data transfer offset.

16^{th} to 19^{th} fields of the data out UPIU include information on the number of bytes of data to be transmitted via a corresponding UPIU. In other words, a data buffer offset.

20^{th} to 31^{st} fields of the data out UPIU are used as status information areas SIA.

An end-to-end CRC code of a header is optionally added following the 31^{st} field of the data out UPIU. For example, if a first bit of the 0^{th} field is ‘0’, the end-to-end CRC code may be omitted. In this case, a k^{th} field of the data out UPIU may be a 32^{nd} field following the 31^{st} field.

The k^{th} field of the data out UPIU and following fields thereof (e.g., k+1 to k+Length−1) may include output data.

An end-to-end CRC code of data is optionally added following output data fields. For example, if a second bit of the 0^{th} field is ‘0’, the end-to-end CRC code of data may be omitted.

The 4^{th} to 7^{th} fields, the 9^{th} field, and the 20^{th} to 31^{st} fields of the data out UPIU are used as a status information area SIA. Status information may be added as at least one field or at least one bit of the status information area SIA.

For example, as described with reference to FIG. 4, two or more status information may be included at a predetermined location. As described with reference to FIG. 5, two or more status information may be included together with flag data. As described with reference to FIG. 6, two or more status information may be included together with status information map data.

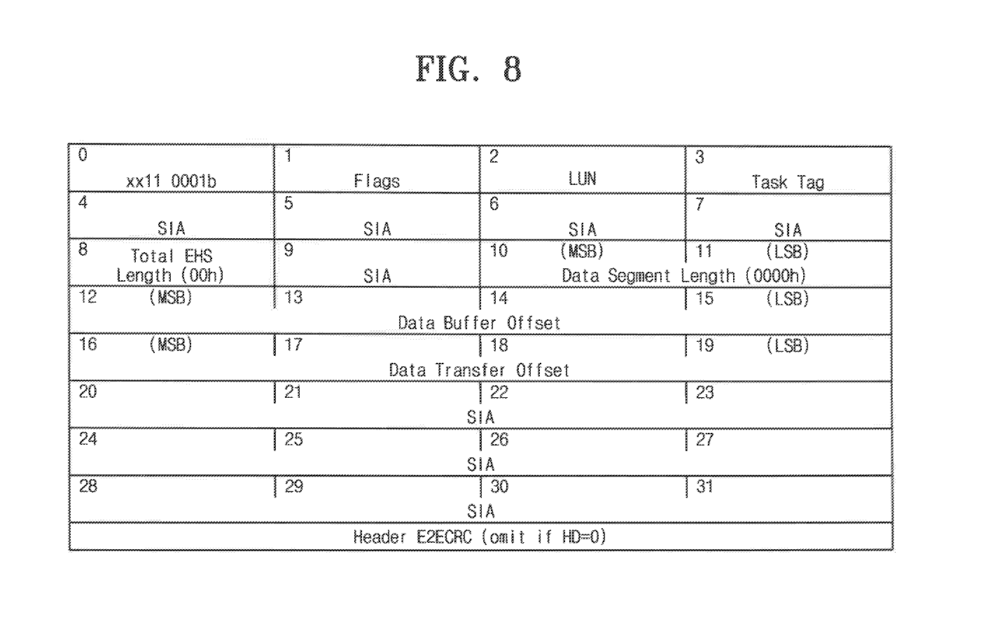

FIG. 8 shows a format of data that the storage device 100 outputs, according to an exemplary embodiment of the inventive concept. In an exemplary embodiment of the inventive concept, the storage device 100 may output data according to a format of UPIU according to the UFS specification.

Referring to FIG. 8, the storage device 100 outputs a ready to transfer UPIU. The ready to transfer UPIU is formed of a plurality of fields. Each field of the ready to transfer UPIU is referred to using a number marked in a box. Each field of the ready to transfer UPIU includes 1-byte data.

A 0^{th} field of the ready to transfer UPIU includes information on a transaction type. For example, a transaction code assigned to the ready to transfer UPIU is ‘110001b’. A 1^{st} field of the ready to transfer UPIU is a flag field and is not used in a ready to transfer UPIU. A 2^{nd} field of the ready to transfer UPIU stores information on a LUN of a target device, and a 3^{rd} field of the ready to transfer UPIU includes information on a task tag.

4^{th} to 7^{th} fields of the ready to transfer UPIU may be used as a status information area SIA.

An 8^{th} field of the ready to transfer UPIU includes a total length of an EHS. A 9^{th} field of the ready to transfer UPIU is used as a status information area SIA. 10^{th} and 11^{th} fields of the ready to transfer UPIU indicate information on the number of valid bytes of a data segment and are not used in the ready to transfer UPIU.

12^{th} to 15^{th} fields of the ready to transfer UPIU may include information on a start location of data to be transmitted. In other words, a data buffer offset.

16^{th} to 19^{th} fields of the ready to transfer UPIU include information on the number of bytes that an external host device requests. In other words, a data transfer offset.

20^{th} to 31^{st} fields of the ready to transfer UPIU are used as status information areas SIA.

An end-to-end CRC code of a header is optionally added following the 31^{st} field of the ready to transfer UPIU. For example, if a first bit of the 0^{th} field is ‘0’, the end-to-end CRC code of the header may be omitted.

The 4^{th} to 7^{th} fields, the 9^{th} field, and the 20^{th} to 31^{st} fields of the ready to transfer UPIU are used as a status information area SIA. Status information may be added as at least one field or at least one bit of the status information area SIA.

For example, as described with reference to FIG. 4, two or more status information may be included at a predetermined location. As described with reference to FIG. 5, two or more status information may be included together with flag data. As described with reference to FIG. 6, two or more status information may be included together with status information map data.

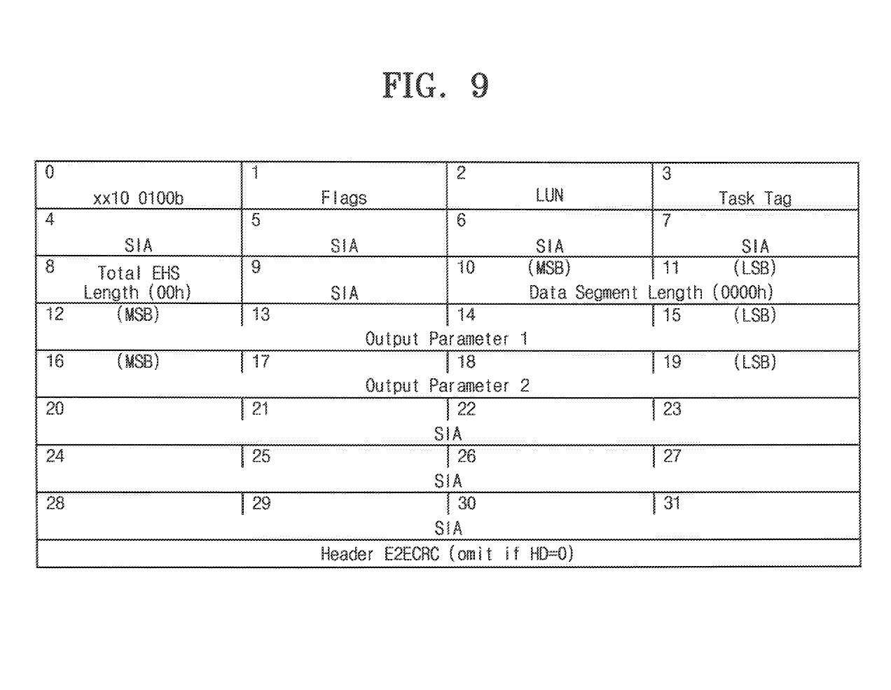

FIG. 9 shows a format of data that the storage device 100 outputs, according to an exemplary embodiment of the inventive concept. In an exemplary embodiment of the inventive concept, the storage device 100 may output data according to a format of UPIU according to the UFS specification.

Referring to FIG. 9, the storage device 100 outputs a task management response UPIU. The task management response UPIU is formed of a plurality of fields. Each field of the task management response UPIU is referred to using a number marked in a box. Each field of the task management response UPIU includes 1-byte data.

A 0^{th} field of the task management response UPIU includes information on a transaction type. For example, a transaction code assigned to the task management response UPIU is ‘100100b’. A 1^{st} field of the task management response UPIU is a flag field and is not used in a task management response UPIU. A 2^{nd} field of the task management response UPIU stores information on a LUN of a target device, and a 3^{rd} field of the task management response UPIU includes information on a task tag.

4^{th} to 7^{th} fields of the task management response UPIU may be used as a status information area SIA.

An 8^{th} field of the task management response UPIU includes a total length of an EHS. A 9^{th} field of the task management response UPIU is used as a status information area SIA. 10^{th} and 11^{th} fields of the task management response UPIU indicate information on the number of valid bytes of a data segment and are not used in the task management response UPIU.

12^{th} to 19^{th} fields of the task management response UPIU may include information on a task management service response. In other words, output parameters 1 and 2. For example, the 12^{th} to 19^{th} fields may include information indicating whether a requested task is completed, whether a task is a task that the storage device 100 does not support, whether a task fails or succeeds, whether a LUN is correct, and so on.

20^{th} to 31^{st} fields of the task management response UPIU are used as status information areas SIA.

An end-to-end CRC code of a header is optionally added following the 31^{st} field of the task management response UPIU. For example, if a first bit of the 0^{th} field is ‘0’, the end-to-end CRC code of the header may be omitted.

The 4^{th} to 7^{th} fields, the 9^{th} field, and the 20^{th} to 31^{st} fields of the task management response UPIU are used as a status information area SIA. Status information may be added as at least one field or at least one bit of the status information area SIA.

For example, as described with reference to FIG. 4, two or more status information may be included at a predetermined location. As described with reference to FIG. 5, two or more status information may be included together with flag data. As described with reference to FIG. 6, two or more status information may be included together with status information map data.

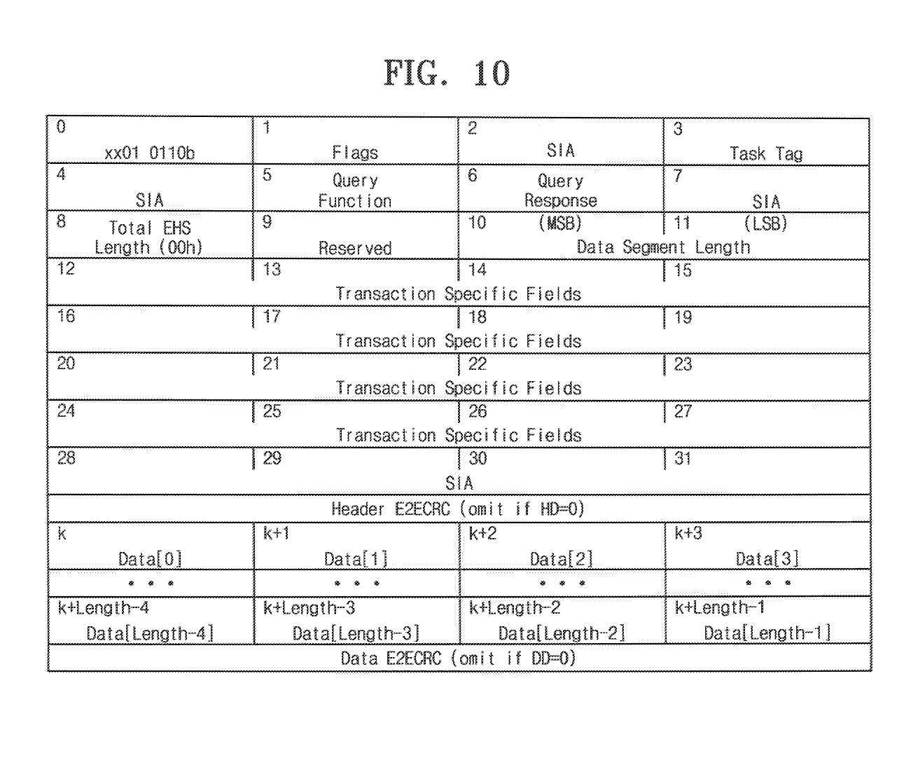

FIG. 10 shows a format of data that the storage device 100 outputs, according to an exemplary embodiment of the inventive concept. In an exemplary embodiment of the inventive concept, the storage device 100 may output data according to a format of UPIU according to the UFS specification.

Referring to FIG. 10, the storage device 100 outputs a query response UPIU. The query response UPIU is formed of a plurality of fields. Each field of the query response UPIU is referred to using a number marked in a box. Each field of the query response UPIU includes 1-byte data.

A 0^{th} field of the query response UPIU includes information on a transaction type. For example, a transaction code assigned to the query response UPIU is ‘010110b’. A 1^{st} field of the query response UPIU is a flag field and is not used in a query response UPIU. A 2^{nd} field of the query response UPIU is used as a status information area SIA. A 3^{rd} field of the query response UPIU includes information on a task tag.

A 4^{th} field of the query response UPIU is used as a status information area SIA. A 5^{th} field of the query response UPIU includes an original query function value received via a query request UPIU. A 6^{th} field of the query response UPIU includes information on an operation that is executed according to the query request UPIU. A 7^{th} field of the query response UPIU is used as a status information area SIA.

An 8^{th} field of the query response UPIU includes a total length of an EHS. A 9^{th} field of the query response UPIU includes device information and is reserved. 10^{th} and 11^{th} fields of the query response UPIU indicate information on the number of valid bytes of a data segment.

12^{th} to 27^{th} fields of the query response UPIU may include a variety of information according to a type of query response UPIU, which will be described later. In other words, transaction specific fields.

28^{th} to 31^{st} fields of the query response UPIU are used as status information areas SIA.

An end-to-end CRC code of a header is optionally added following the 31^{st} field of the query response UPIU. For example, if a first bit of the 0^{th} field is ‘0’, the end-to-end CRC code of the header may be omitted. In this case, a kfth field of the query response UPIU may be a 32^{nd} field following the 31^{st} field.

The k^{th} field of the query response UPIU and following fields thereof (e.g., k+1 to k+Length−1) may include output data. For example, data fields may be provided selectively according to a type of a query response UPIU.

An end-to-end CRC code of data is optionally added following output data fields. For example, if a first bit of the 0^{th} field is ‘0’, the end-to-end CRC code of the data may be omitted.

The 2^{nd}, 4^{th}, 7^{th}, and 28^{th} to 31^{st} fields of the query response UPIU are used as a status information area SIA. Status information may be added as at least one field or at least one bit of the status information area SIA.

For example, as described with reference to FIG. 4, two or more status information may be included at a predetermined location. As described with reference to FIG. 5, two or more status information may be included together with flag data. As described with reference to FIG. 6, two or more status information may be included together with status information map data.

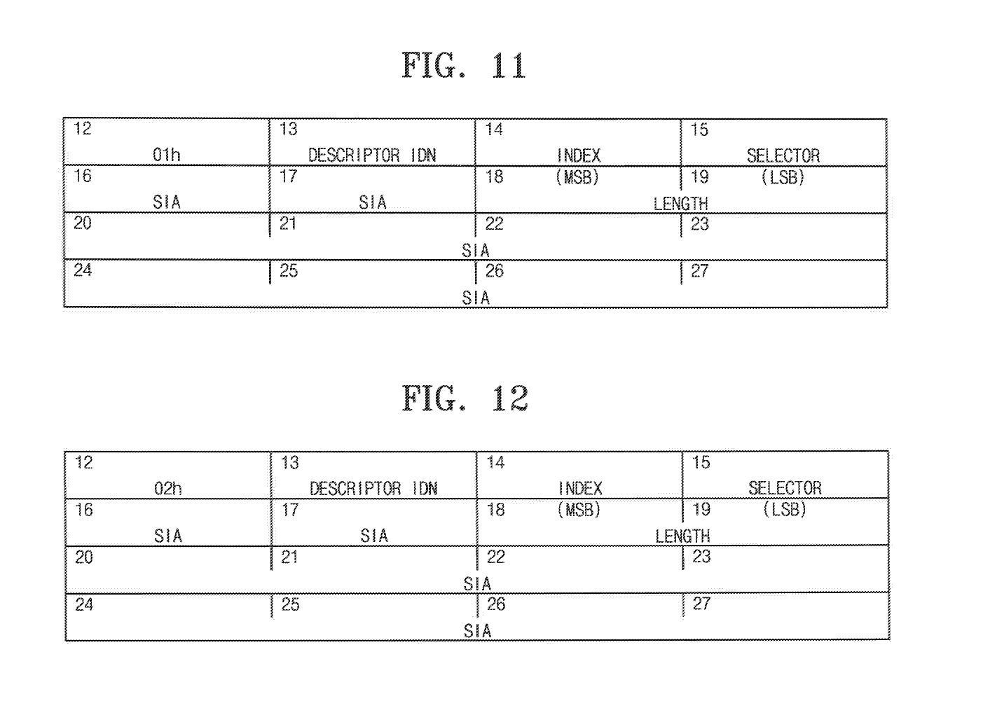

FIG. 11 shows the 12^{th} to 27^{th} fields shown in FIG. 10, according to an exemplary embodiment of the inventive concept. In FIG. 11, there are illustrated 12^{th} to 27^{th} fields of a query response UPIU that are generated according to a query request UPIU requesting a read descriptor.

Referring to FIG. 11, the 12^{th} field includes information on an opcode. An opcode associated with a read descriptor may be ‘01h’. The 13^{th} field is associated with an opcode and includes the same descriptor identification number (IDN) as the query request UPIU. The 14^{th} field is an index field and includes the same index value as the query request UPIU. The 15^{th} field is a selector field and includes the same selector value as the query request UPIU.

The 16^{th} and 17^{th} fields are used as a status information area SIA. The 18^{th} and 19^{th} fields include information on the number of bytes returned according to the query request UPIU.

The 20^{th} to 27^{th} fields are used as a status information area SIA.

The query response UPIU associated with the read descriptor may use the 16^{th}, 17^{th}, and 20^{th} to 27^{th} fields as a status information area SIA.

FIG. 12 shows the 12^{th} to 27^{th} fields shown in FIG. 10, according to an exemplary embodiment of the inventive concept. In FIG. 12, there are illustrated 12^{th} to 27^{th} fields of a query response UPIU that are generated according to a query request UPIU requesting a write descriptor.

Referring to FIG. 12, the 12^{th} field includes information on an opcode. An opcode associated with a write descriptor may be ‘02h’. The 13^{th} field is associated with an opcode and includes the same descriptor identification number (IDN) as the query request UPIU. The 14^{th} field is an index field and includes the same index value as the query request UPIU. The 15^{th} field is a selector field and includes the same selector value as the query request UPIU.

The 16^{th} and 17^{th} fields are used as a status information area SIA. The 18^{th} and 19^{th} fields include information on the number of descriptor bytes written according to the query request UPIU.

The 20^{th} to 27^{th} fields are used as a status information area SIA.

The query response UPIU associated with the write descriptor may use the 16^{th}, 17^{th}, and 20^{th} to 27^{th} fields as a status information area SIA.

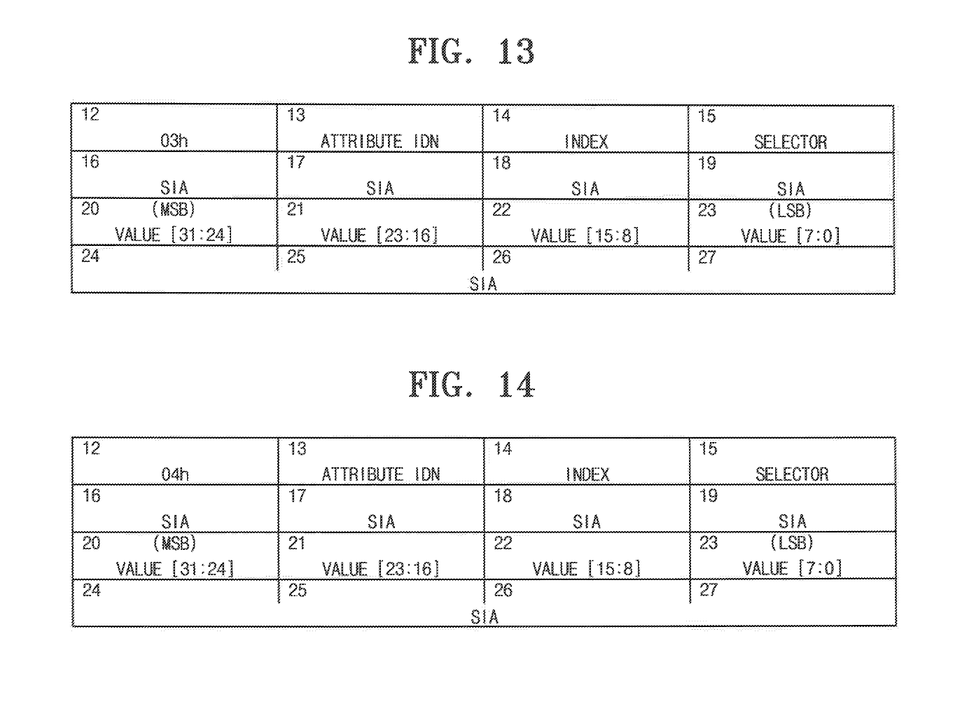

FIG. 13 shows the 12^{th} to 27^{th} fields shown in FIG. 10, according to an exemplary embodiment of the inventive concept. In FIG. 13, there are illustrated 12^{th} to 27^{th} fields of a query response UPIU that are generated according to a query request UPIU requesting read attributes.

Referring to FIG. 13, the 12^{th} field includes information on an opcode. An opcode associated with read attributes may be ‘03h’. The 13^{th} field is associated with an opcode and includes the same attribute identification number (IDN) as the query request UPIU. The 14^{th} field is an index field and includes the same index value as the query request UPIU. The 15^{th} field is a selector field and includes the same selector value as the query request UPIU.

The 16^{th} though 19^{th} fields are used as a status information area SIA.

The 20^{th} to 23^{rd} fields include a value of read attributes.

The 24^{th} to 27^{th} fields are used as a status information area SIA.

The query response UPIU associated with the read attributes may use the 16^{th} to 19^{th} and 24^{th} to 27^{th} fields as a status information area SIA.

FIG. 14 shows the 12^{th} to 27^{th} fields shown in FIG. 10, according to an exemplary embodiment of the inventive concept. In FIG. 14, there are illustrated 12^{th} to 27^{th} fields of a query response UPIU that are generated according to a query request UPIU requesting write attributes.

Referring to FIG. 14, the 12^{th} field includes information on an opcode. An opcode associated with write attributes may be ‘04h’. The 13^{th} field is associated with an opcode and includes the same attribute identification number (IDN) as the query request UPIU. The 14^{th} field is an index field and includes the same index value as the query request UPIU. The 15^{th} field is a selector field and includes the same selector value as the query request UPIU.

The 16^{th} through 19^{th} fields are used as a status information area SIA.

The 20^{th} to 23^{rd} fields include a value of write attributes.

The 24^{th} to 27^{th} fields are used as a status information area SIA.

The query response UPIU associated with the write attributes may use the 16^{th} to 19^{th} and 24^{th} to 27^{th} fields as a status information area SIA.

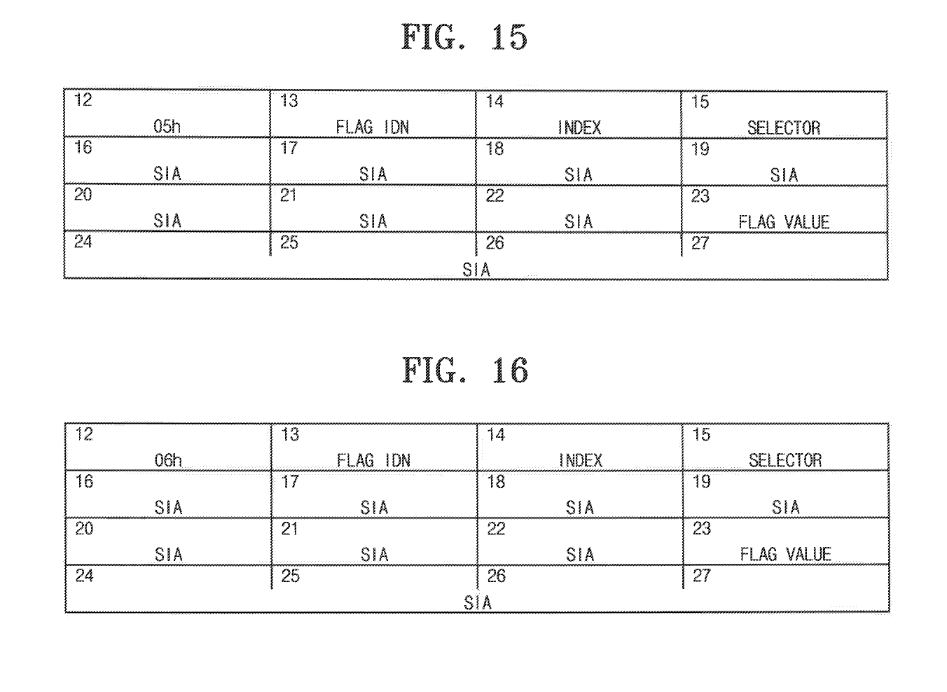

FIG. 15 shows the 12^{th} to 27^{th} fields shown in FIG. 10, according to an exemplary embodiment of the inventive concept. In FIG. 15, there are illustrated 12^{th} to 27^{th} fields of a query response UPIU that are generated according to a query request UPIU requesting a read flag.

Referring to FIG. 15, the 12^{th} field includes information on an opcode. An opcode associated with a read flag may be ‘05h’. The 13^{th} field is associated with an opcode and includes the same flag identification number (IDN) as the query request UPIU. The 14^{th} field is an index field and includes the same index value as the query request UPIU. The 15^{th} field is a selector field and includes the same selector value as the query request UPIU.

The 16^{th} through 22^{nd} fields are used as a status information area SIA.

The 23^{rd} field includes a flag value.

The 24^{th} to 27^{th} fields are used as a status information area SIA.

The query response UPIU associated with the read flag may use the 16^{th} to 22^{nd} and 24^{th} to 27^{th} fields as a status information area SIA.

FIG. 16 shows the 12^{th} to 27^{th} fields shown in FIG. 10, according to an exemplary embodiment of the inventive concept. In FIG. 16, there are illustrated 12^{th} to 27^{th} fields of a query response UPIU that are generated according to a query request UPIU requesting a set flag.

Referring to FIG. 16, the 12^{th} field includes information on an opcode. An opcode associated with a set flag may be ‘06h’. The 13^{th} field is associated with an opcode and includes the same flag identification number (IDN) as the query request UPIU. The 14^{th} field is an index field and includes the same index value as the query request UPIU. The 15^{th} field is a selector field and includes the same selector value as the query request UPIU.

The 16^{th} through 22^{nd} fields are used as a status information area SIA.

The 23^{rd} field includes a flag value.

The 24^{th} to 27^{th} fields are used as a status information area SIA.

The query response UPIU associated with the set flag may use the 16^{th} to 22^{nd} and 24^{th} to 27^{th} fields as a status information area SIA.

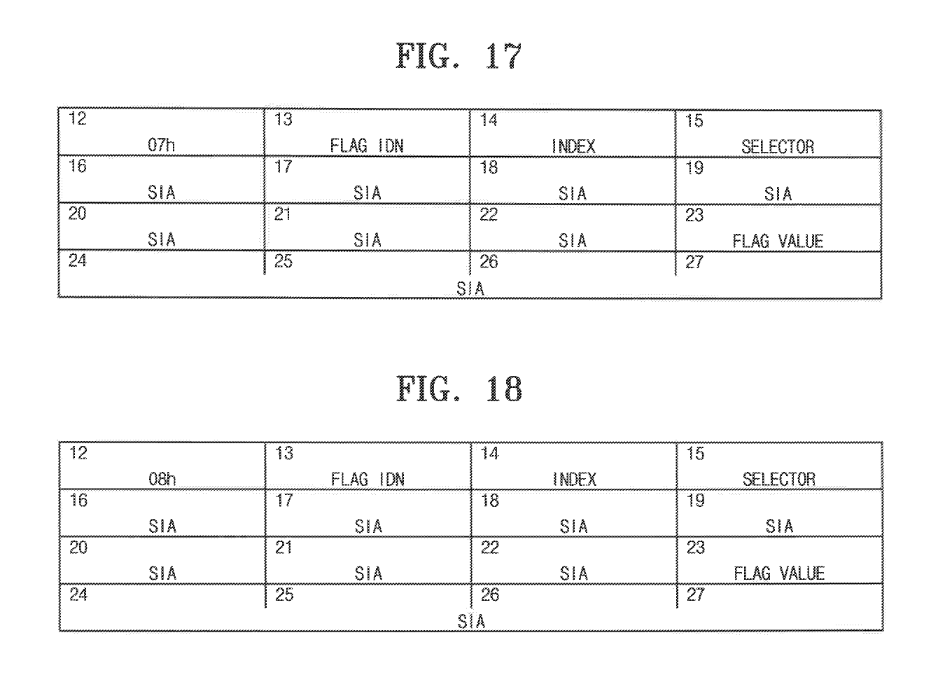

FIG. 17 shows the 12^{th} to 27^{th} fields shown in FIG. 10, according to an exemplary embodiment of the inventive concept. In FIG. 17, there are illustrated 12^{th} to 27^{th} fields of a query response UPIU that are generated according to a query request UPIU requesting a clear flag.

Referring to FIG. 11, the 12^{th} field includes information on an opcode. An opcode associated with the clear flag may be ‘07h’. The 13^{th} field is associated with an opcode and includes the same flag identification number (IDN) as the query request UPIU. The 14^{th} field is an index field and includes the same index value as the query request UPIU. The 15^{th} field is a selector field and includes the same selector value as the query request UPIU.

The 16^{th} through 22^{nd} fields are used as a status information area SIA.

The 23^{rd} field includes a flag value.

The 24^{th} to 27^{th} fields are used as a status information area SIA.

The query response UPIU associated with the clear flag may use the 16^{th} to 22^{nd} and 24^{th} to 27^{th} fields as a status information area SIA.

FIG. 18 shows the 12^{th} to 27^{th} fields shown in FIG. 10, according to an exemplary embodiment of the inventive concept. In FIG. 18, there are illustrated 12^{th} to 27^{th} fields of a query response UPIU that are generated according to a query request UPIU requesting a toggle flag.

Referring to FIG. 11, the 12^{th} field includes information on an opcode. An opcode associated with the toggle flag may be ‘08h’. The 13^{th} field is associated with an opcode and includes the same flag identification number (IDN) as the query request UPIU. The 14^{th} field is an index field and includes the same index value as the query request UPIU. The 15^{th} field is a selector field and includes the same selector value as the query request UPIU.

The 16^{th} through 22^{nd} fields are used as a status information area SIA.

The 23^{rd} field includes a flag value.

The 24^{th} to 27^{th} fields are used as a status information area SIA.

The query response UPIU associated with the toggle flag may use the 16^{th} to 22^{nd} and 24^{th} to 27^{th} fields as a status information area SIA.

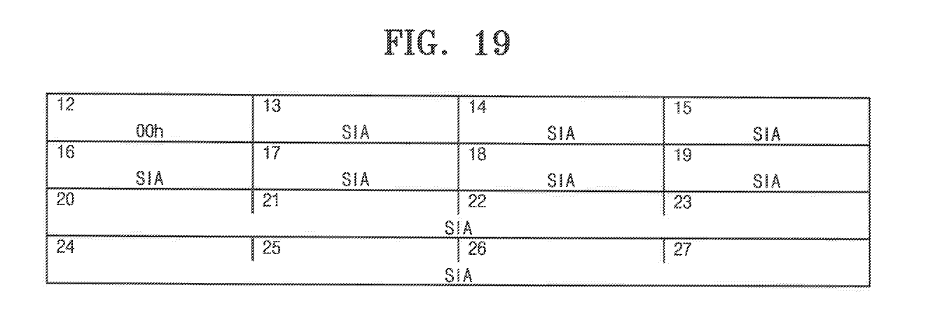

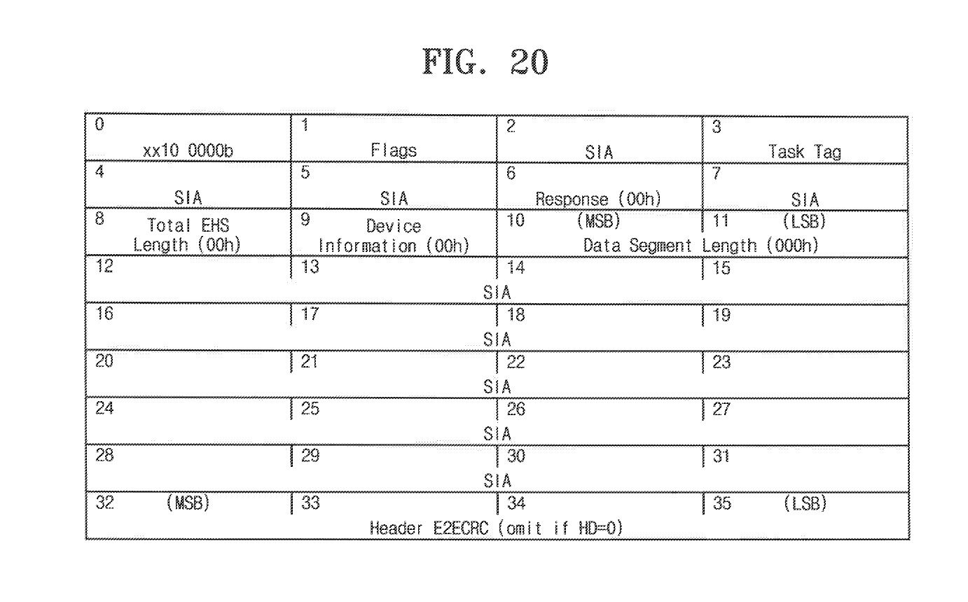

FIG. 19 shows the 12^{th} to 27^{th} fields shown in FIG. 10, according to an exemplary embodiment of the inventive concept. In FIG. 19, there are illustrated 12^{th} to 27^{th} fields of a query response UPIU that are generated according to an NOP query request UPIU.

Referring to FIG. 19, the 12^{th} field includes information on an opcode. An opcode associated with the NOP may be ‘00h’. The 13^{th} to 27^{th} fields are used as a status information area SIA. A query response UPIU associated with the NOP may use the 13^{th} to 27^{th} fields as a status information area SIA.

FIG. 20 shows a format of data that the storage device 100 outputs, according to an exemplary embodiment of the inventive concept. In an exemplary embodiment of the inventive concept, the storage device 100 may output data according to a format of UPIU according to the UFS specification.

Referring to FIG. 20, the storage device 100 outputs a NOP IN UPIU. The NOP IN UPIU is formed of a plurality of fields. Each field of the NOP IN UPIU is referred to using a number marked in a box. Each field of the NOP IN UPIU includes 1-byte data.

A 0^{th} field of the NOP IN UPIU includes information on a transaction type. For example, a transaction code assigned to the response UPIU is ‘100000b’. A 1^{st} field of the NOP IN UPIU is a flag field and is not used in the NOP IN UPIU. A 2^{nd} field of the NOP IN UPIU is used as a status information area SIA. A 3^{rd} field of the NOP IN UPIU contains information on a task tag.

4^{th} and 5^{th} fields of the NOP IN UPIU are used as a status information area SIA. A 6^{th} field of the NOP IN UPIU contains information indicating that the storage device 100 is ready to respond to a request of an external host device. A 7^{th} field of the NOP IN UPIU is used as a status information area SIA.

An 8^{th} field of the NOP IN UPIU includes a total length of an EHS. A 9^{th} field of the NOP IN UPIU is a device information field. 10^{th} and 11^{th} fields of the NOP IN UPIU indicate information on the number of valid bytes of a data segment and are not used in the NOP IN UPIU.

12^{th} to 31^{st} fields of the NOP IN UPIU are used as status information areas SIA.

An end-to-end CRC code of a header is optionally added following the 31^{st} field of the NOP IN UPIU. For example, if a first bit of the 0^{th} field is ‘0’, the end-to-end CRC code of the header may be omitted.

The 2^{nd}, 4^{th}, 5^{th}, 7^{th}, and 12^{th} to 31^{st} fields of the NOP IN UPIU are used a status information area SIA. Status information may be added as at least one field or at least one bit of the status information area SIA.

For example, as described with reference to FIG. 4, two or more status information may be included at a predetermined location. As described with reference to FIG. 5, two or more status information may be included together with flag data. As described with reference to FIG. 6, two or more status information may be included together with status information map data.

In the data formats described with reference to FIGS. 3 to 20, 24^{th} to 31^{st} fields may be used as status information areas SIA in common. Thus, status information may be added as at least one bit or at least one field of the 24^{th} to 31^{st} fields that the storage device 100 outputs.

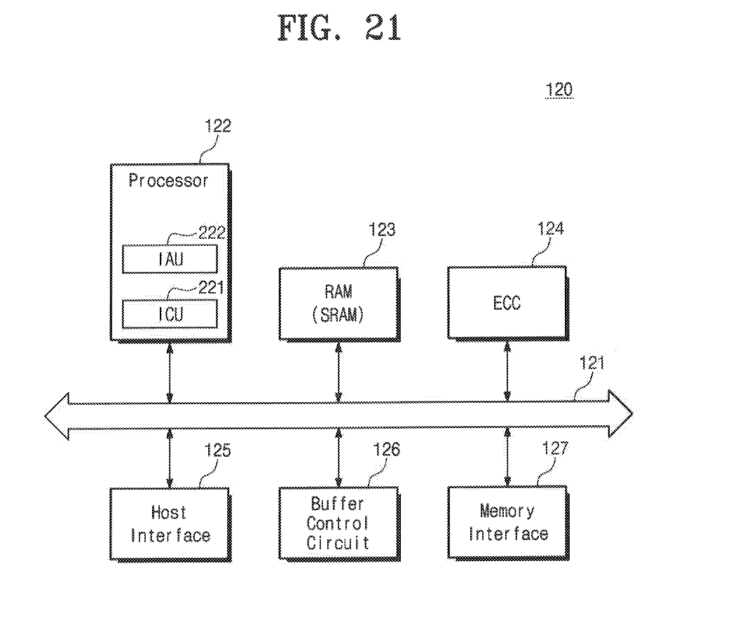

FIG. 21 is a block diagram illustrating a memory controller 120 according to an exemplary embodiment of the inventive concept. Referring to FIG. 21, the memory controller 120 includes a bus 121, a processor 122, a RAM 123, an error correcting code (ECC) block 124, a host interface 125, a buffer control circuit 126 and a memory interface 127.

The bus 121 may be configured to provide a channel among components of the memory controller 120.

The processor 122 controls an overall operation of the memory controller 120 and executes a logical operation. The processor 122 communicates with an external host through the host interface 125. The processor 122 stores commands or addresses received via the host interface 125 in the RAM 123. The processor 122 may store data received via the host interface 125 in the RAM 123. The processor 122 generates internal commands and addresses according to commands or addresses stored in the RAM 123 and outputs them via the memory interface 127. The processor 122 outputs data stored in the RAM 123 via the memory interface 127. The processor 122 may store data received via the memory interface 127 in the RAM 123. The processor 122 may output data stored in the RAM 123 via the host interface 125 or the memory interface 127. For example, the processor 122 may include a direct memory access (DMA) and output data using the DMA.

The processor 122 includes an information collection unit 221 and an information addition unit 222. In other words, the processor 122 collects status information of the storage device 100 (refer to FIG. 1) and outputs the collected status information via the host interface 125.

In an exemplary embodiment of the inventive concept, the processor 122 may control the memory controller 120 using codes. The processor 122 may load codes from a nonvolatile memory (e.g., a read only memory) included in the memory controller 120. Or, the processor 122 may load codes received from the memory interface 127.

The RAM 123 is used as a work memory, a cache memory, or a buffer memory of the processor 122. The RAM 123 stores codes or instructions that the processor 122 will execute. The RAM 123 stores data processed by the processor 122. The RAM 123 may include a static RAM (SRAM).

The ECC block 124 performs error correction. The ECC block 124 generates parities for error correction based on data to be output to the memory interface 127. Data and parities may be output through the memory interface 127. The ECC block 124 corrects an error of data using data and parities received through the memory interface 127.

The host interface 125 communicates with the external host according to a control of the processor 122. The host interface 125 may communicate using at least one of various communication techniques such as Universal Serial Bus (USB), Serial Advanced Technology Attachment (SATA), High Speed Interchip HSIC), SCSI, Firewire, Peripheral Component Interconnection (PCI), PCI express (PCIe), NonVolatile Memory express (NVMe), UFS, Secure Digital (SD), MultiMedia Card (MMC), embedded MMC (eMMC), and so on.

The memory interface 127 is configured to communicate with the nonvolatile memory 110 (refer to FIG. 1) according to a control of the processor 122.

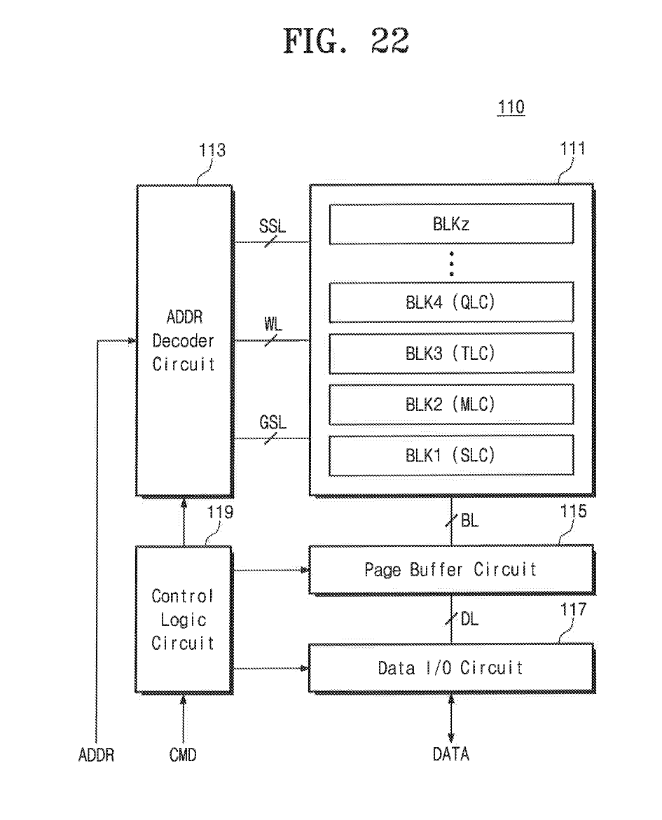

FIG. 22 is a block diagram illustrating a nonvolatile memory 110 according to an exemplary embodiment of the inventive concept. Referring to FIG. 22, the nonvolatile memory 110 includes a memory cell array 111, an address decoder circuit 113, a page buffer circuit 115, a data input/output circuit 117, and a control logic circuit 119.

The memory cell array 111 includes a plurality of memory blocks BLK1 to BLKz, each of which has a plurality of memory cells. Each memory block is connected to the address decoder circuit 113 through at least one string selection line SSL, a plurality of word lines WL, and at least one ground selection line GSL. The memory cell array 111 is connected to the page buffer circuit 115 through a plurality of bit lines BL. The memory blocks BLK1 to BLKz may be connected in common to the plurality of bit lines BL. Memory cells of the memory blocks BLK1 to BLKz may have the same structure, or not. For example, the first memory block BLK1 may have single level cell (SLC) memory cells, the second memory block BLK2 may have multi level cell (MLC) memory cells, the third memory block BLK3 may have tri level cell (TLC) memory cells and the fourth memory block BLK4 may have quad level cell (QLC) memory cells.

The address decoder circuit 113 is connected to the memory cell array 111 through a plurality of ground selection lines GSL, the plurality of word lines WL, and a plurality of string selection lines SSL. The address decoder circuit 113 operates according to a control of the control logic circuit 119. The address decoder circuit 113 receives an address from the memory controller 120 (refer to FIG. 1). The address decoder circuit 113 decodes an input address ADDR and controls voltages to be applied to the word lines WL according to the decoded address. For example, at a programming, the address decoder circuit 113 applies a pass voltage to the word lines WL according to a control of the control logic circuit 119. At the programming, the address decoder circuit 113 further applies a program voltage to a word line, selected by an address ADDR, from among the word lines WL according to a control of the control logic circuit 119.

The page buffer circuit 115 is connected to the memory cell array 111 through the bit lines BL. The page buffer circuit 115 is connected to the data input/output circuit 117 through a plurality of data lines DL. The page buffer circuit 115 operates according to a control of the control logic circuit 119.

The page buffer circuit 115 holds data to be programmed at memory cells of the memory cell array 111 or data read from the memory cells of the memory cell array 111. During a program operation, the page buffer circuit 115 stores data to be stored in memory cells. The page buffer circuit 115 biases the plurality of bit lines BL based on the stored data. The page buffer circuit 115 functions as a write driver at a program operation. During a read operation, the page buffer circuit 115 senses voltages on the bit lines BL and stores sensing results. The page buffer circuit 115 functions as a sense amplifier at a read operation.

The data input/output circuit 117 is connected to the page buffer circuit 115 through the data lines DL. The data input/output circuit 117 exchanges data DATA with the memory controller 120 (refer to FIG. 1).

The data input/output circuit 117 temporarily stores data, which the memory controller 120 provides, and transfers the stored data to the page buffer circuit 115. The data input/output circuit 117 temporarily stores data transferred from the page buffer circuit 115 and transfers the stored data to the memory controller 120. The data input/output circuit 117 functions as a buffer memory.

The control logic circuit 119 receives a command CMD from the memory controller 120. The control logic circuit 119 decodes the received command and controls an overall operation of the nonvolatile memory 110 according to the decoded command. The control logic circuit 119 further receives a variety of control signals and voltages from the memory controller 120 (refer to FIG. 1).

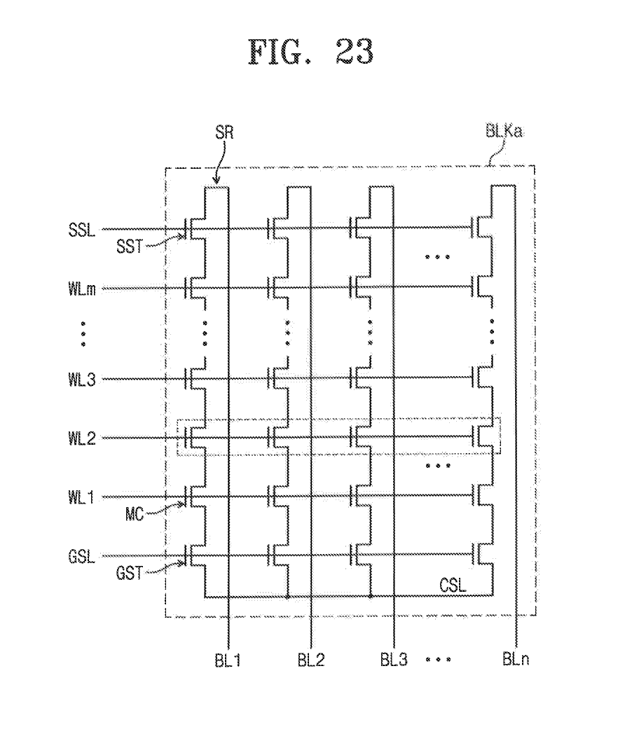

FIG. 23 is a circuit diagram illustrating a memory block BLKa according to an exemplary embodiment of the inventive concept. In FIG. 23, there is illustrated one BLKa of a plurality of memory blocks BLK1 to BLKz of the memory cell array 111 shown in FIG. 22.

Referring to FIG. 23, the memory block BLKa includes a plurality of strings SR, which are connected to a plurality of bit lines BL1 to BLn, respectively. Each string SR contains a ground selection transistor GST, memory cells MC, and a string selection transistor SST.

In each string SR, the ground selection transistor GST is connected between the memory cells MC and a common source line CSL. The ground selection transistors GST of the strings SR are connected in common to the common source line CSL.

In each string SR, the string selection transistor SST is connected between the memory cells MC and a bit line BL. The string selection transistors SST of the strings SR are connected to a plurality of bit lines BL1 to BLn, respectively.

In each string SR, the plurality of memory cells MC are connected between the ground selection transistor GST and the string selection transistor SST. In each string SR, the plurality of memory cells MC are connected in series.

In the strings SR, memory cells MC having the same height from the common source line CSL are connected in common to a word line. The memory cells MC of the strings SR are connected to a plurality of word lines WL1 to WLm.

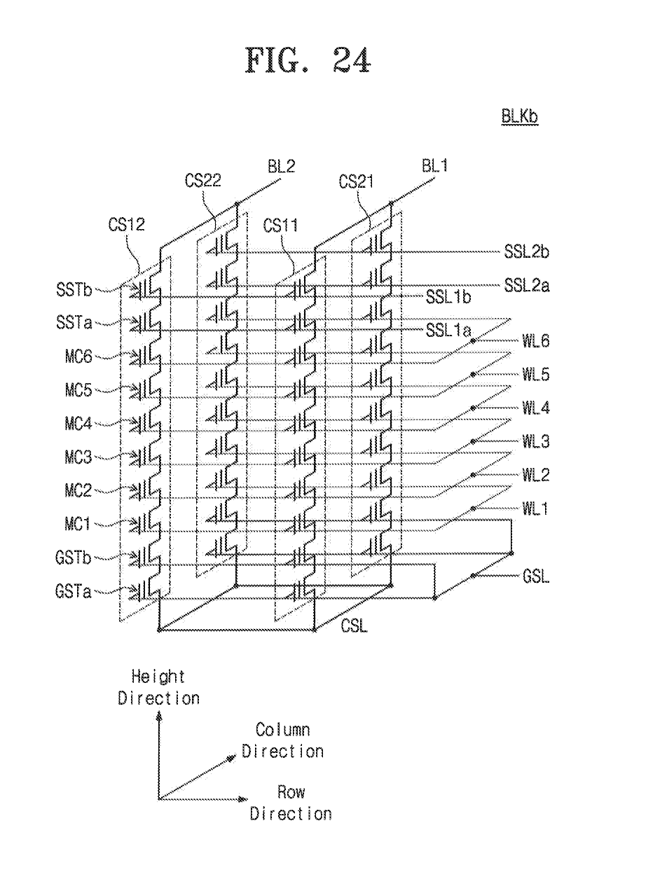

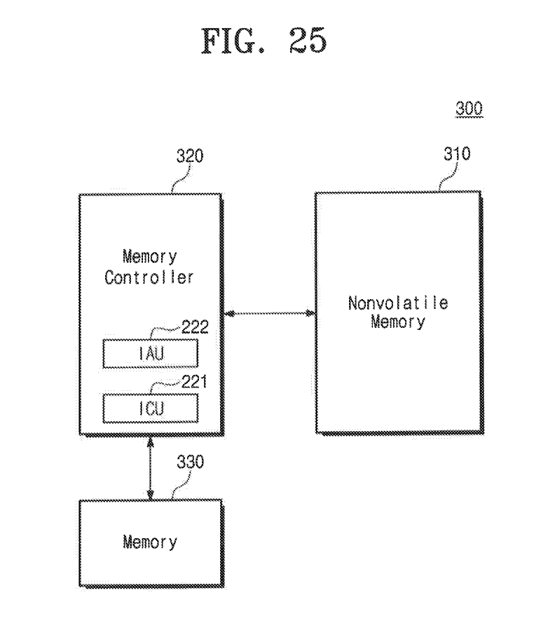

FIG. 24 is a circuit diagram illustrating a memory block BLKb according to an exemplary embodiment of the inventive concept. Referring to FIG. 24, the memory block BLKb includes a plurality of cell strings CS11 to CS21 and CS12 to CS22. The plurality of cell strings CS11 to CS21 and CS12 to CS22 are arranged along a row direction and a column direction and form rows and columns.

For example, the cell strings CS11 and CS12 arranged along the row direction form a first row, and the cell strings CS21 and CS22 arranged along the row direction form a second row. The cell strings CS11 and CS21 arranged along the column direction form a first column, and the cell strings CS12 and CS22 arranged along the column direction form a second column.

The cell transistors include ground selection transistors GSTa and GSTb, memory cells MC1 to MC6, and string selection transistors SSTa and SSTb. The ground selection transistors GSTa and GSTb, memory cells MC1 to MC6, and string selection transistors SSTa and SSTb of each cell string are stacked in a height direction perpendicular to a plane (e.g., a plane above a substrate of the memory block BLKb) on which the cell strings CS11 to CS21 and CS12 to CS22 are arranged in rows and columns.

Each cell transistor may be formed of a charge trap type cell transistor of which a threshold voltage is varied according to the amount of charge trapped in its insulation film.

Lowermost ground selection transistors GSTa are connected in common to a common source line CSL.

The ground selection transistors GSTa and GSTb of the plurality of cell strings CS11 to CS21 and CS12 to CS22 are connected in common to a ground selection line GSL.

In an exemplary embodiment of the inventive concept, ground selection transistors at the same height (or, order from the substrate) may be connected to the same ground selection line, and ground selection transistors at a different height (or, order from the substrate) may be connected to different a ground selection line. For example, the ground selection transistors GSTa with a first height may be connected in common to a first ground selection line, and the ground selection transistors GSTb with a second height may be connected in common to a second ground selection line.

In an exemplary embodiment of the inventive concept, ground selection transistors in the same row may be connected to the same ground selection line, and ground selection transistors in a different row may be connected to a different ground selection line. For example, the ground selection transistors GSTa and GSTb of the cell strings CS11 and CS12 in the first row are connected in common to a first ground selection line, and the ground selection transistors GSTa and GSTb of the cell strings CS21 and CS22 in the second row are connected in common to a second ground selection line.

Word lines are in common connected to memory cells that are placed at the same height (or, order) from the substrate (or, the ground selection transistors GST). Memory cells that are placed at different heights (or, orders) from the substrate (or, the ground selection transistors GST) are connected to different word lines WL1 to WL6. For example, the memory cells MC1 are connected in common to the word line WL1, the memory cells MC2 are connected in common to the word line WL2, and the memory cells MC3 are connected in common to the word line WL3. The memory cells MC4 are connected in common to the word line WL4, the memory cells MC5 are connected in common to the word line WL5, and the memory cells MC6 are connected in common to the word line WL6.

In first string selection transistors SSTa, having the same height (or, order), of the cell strings CS11 to CS21 and CS12 to CS22, the first string selection transistors SSTa in different rows are connected to different string selection lines SSL1a and SSL2a. For example, the first string selection transistors SSTa of the cell strings CS11 and CS12 are connected in common to the string selection line SSL1a, and the first string selection transistors SSTa of the cell strings CS21 and CS22 are connected in common to the string selection line SSL2a.

In second string selection transistors SSTb, having the same height (or, order), of the cell strings CS11 to CS21 and CS12 to CS22, the second string selection transistors SSTb in different rows are connected to the different string selection lines SSL1b and SSL2b. For example, the second string selection transistors SSTb of the cell strings CS11 and CS12 are connected in common to the string selection line SSL1b, and the second string selection transistors SSTb of the cell strings CS21 and CS22 are connected in common to the string selection line SSL2b.

In other words, cell strings in different rows may be connected to different string selection lines. String selection transistors, having the same height (or, order), of cell strings in the same row are connected to the same string selection line. String selection transistors, having different heights (or, orders), of cell strings in the same row are connected to different string selection lines.

In an exemplary embodiment of the inventive concept, string selection transistors of cell strings in the same row are connected in common to a string selection line. For example, string selection transistors SSTa of the cell strings CS11 and CS12 in the first row are connected in common to the string selection line SSL1a, and string selection transistors SSTa of the cell strings CS21 and CS22 in the second row are connected in common to the string selection line SSL2a.

Columns of the cell strings CS11 to CS21 and CS12 to CS22 are connected to different bit lines BL1 and BL2, respectively. For example, string selection transistors SSTb of the cell strings CS11 and CS21 in the first column are connected in common to the bit line BL1, and string selection transistors SSTb of the cell strings CS12 and CS22 in the second column are connected in common to the bit line BL2.

The memory block BLKb shown in FIG. 24 is exemplary. However, the inventive concept is not limited thereto. For example, the number of rows of cell strings may increase or decrease. As the number of rows of cell strings is changed, the number of string or ground selection lines and the number of cell strings connected to a bit line may also be changed.

The number of columns of cell strings may increase or decrease. As the number of columns of cell strings is changed, the number of bit lines connected to columns of cell strings and the number of cell strings connected to a string selection line may also be changed.

A height of the cell strings may increase or decrease. For example, the number of ground selection transistors, memory cells, or string selection transistors that are stacked in each cell string may increase or decrease.

In an exemplary embodiment of the inventive concept, a write and a read operation may be performed by row. For example, the cell strings CS11 to CS21 and CS12 to CS22 may be selected by row through the string selection lines SSL1a, SSL1b, SSL2a, and SSL2b.

In a selected row of the cell strings CS11 to CS21 and CS12 to CS22, a write or a read operation may be performed by word line. In a selected row of the cell strings CS11 to CS21 and CS12 to CS22, memory cells connected to a selected word line may be programmed.

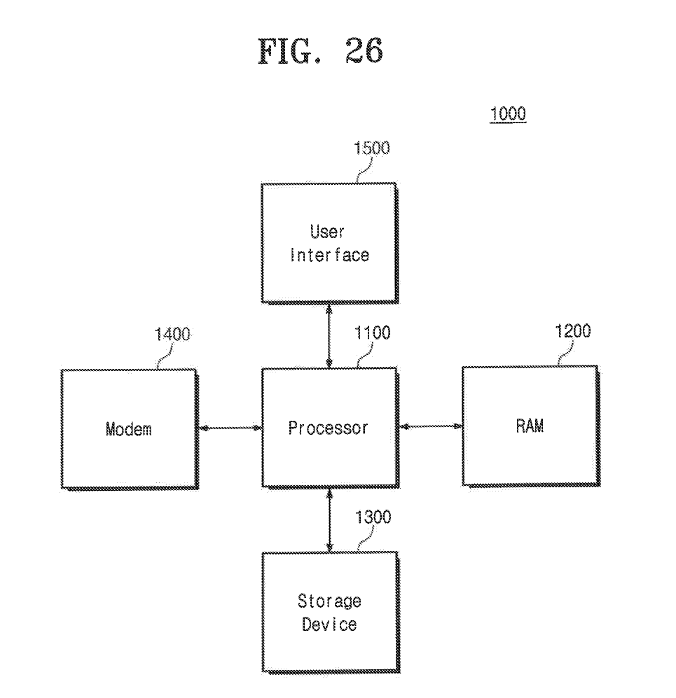

FIG. 25 is a block diagram illustrating a storage device 300 according to an exemplary embodiment of the inventive concept. Referring to FIG. 25, the storage device 300 includes a nonvolatile memory 310, a memory controller 320, and a memory 330. The storage device 300 is different from the storage device 100 described with reference to FIG. 1 in that it further includes the memory 330 outside of the nonvolatile memory 310 and the memory controller 330.

The memory 330 may include a variety of random access memories such as, but not limited to, an SRAM, a dynamic RAM, a synchronous DRAM, a PRAM, an MRAM, an RRAM, an FeRAM, and so on.

The memory controller 320 may use the memory 330 as a buffer memory, a cache memory, or a work memory. The memory controller 320 stores data received from a host device in the memory 330 and writes data stored in the memory 330 at the nonvolatile memory 310. The memory controller 320 stores data read from the nonvolatile memory 310 in the memory 330 and outputs data stored in the memory 330 to the host device. The memory controller 320 stores data read from the nonvolatile memory 310 in the memory 330 and writes data stored in the memory 330 back to the nonvolatile memory 310.

The memory controller 320 stores data or codes necessary to manage the nonvolatile memory 310 in the memory 330. For example, the memory controller 320 reads data or codes necessary to manage the nonvolatile memory 310 from the nonvolatile memory 310 and drives it on the memory 330.

The storage device 300 may be a solid state drive (SSD), a memory card, or an embedded memory.

As illustrated in FIG. 25, the memory controller 320 includes an information collection unit 221 and an information addition unit 222. The information collection unit 221 and the information addition unit 222 may be configured substantially the same as described above with reference to FIG. 1, for example.

FIG. 26 is a block diagram illustrating a computing device 1000 according to an exemplary embodiment of the inventive concept. Referring to FIG. 26, the computing device 1000 includes a processor 1100, a RAM 1200, a storage device 1300, a modem 1400, and a user interface 1500.

The processor 1100 controls an overall operation of the computing device 1000 and performs a logical operation. The processor 1100 is formed of a system-on-chip (SoC). The processor 1100 may be a general purpose processor, a specific-purpose processor, or an application processor.

The RAM 1200 communicates with the processor 1100. The RAM 1200 may be a working memory of the processor 1100 or the computing device 1000. The processor 1100 stores codes or data in the RAM 1200 temporarily. The processor 1100 executes codes using the RAM 1200 to process data. The processor 1100 executes a variety of software, such as, but not limited to, an operating system and an application, using the RAM 1200. The processor 1100 controls an overall operation of the computing device 1000 using the RAM 1200. The RAM 1200 may include a volatile memory such as, but not limited to, an SRAM, a DRAM, an SDRAM, and so on or a nonvolatile memory such as, but not limited to, a PRAM, an MRAM, an RRAM, an FeRAM, and so on.

The storage device 1300 communicates with the processor 1100. The storage device 1300 is used to store data for a long time. In other words, the processor 110 stores data, which is to be stored for a long time, in the storage device 1300. The storage device 1300 stores a boot image for driving the computing device 1000. The storage device 1300 stores source codes of a variety of software, such as an operating system and an application. The storage device 1300 stores data that is processed by a variety of software, such as an operating system and an application.

In an exemplary embodiment of the inventive concept, the processor 1100 drives a variety of software, such as an operating system and an application, by loading source codes stored in the storage device 1300 onto the RAM 1200 and executing codes loaded onto the RAM 1200. The processor 1100 loads data stored in the storage device 1300 onto the RAM 1200 and processes data loaded onto the RAM 1200. The processor 1100 stores data, to be retained for a long time, of data stored in the RAM 1200 in the storage device 1300.

The storage device 1300 includes a nonvolatile memory, such as, but not limited to, a flash memory, a PRAM, an MRAM, an RRAM, an FeRAM, and so on.

The modem 1400 communicates with an external device according to a control of the processor 1100. For example, the modem 1400 communicates with the external device in a wired or wireless manner. The modem 1400 may communicate with the external device, based on at least one of wireless communications techniques such as Long Term Evolution (LTE), Worldwide Interoperability for Microwave Access (WiMax), Global System for Mobile communication (GSM), Code Division Multiple Access (CDMA), Bluetooth, Near Field Communication (NFC), WiFi, Radio Frequency Identification (RFID), and so on. The modem 1400 may communicate with the external device, based on at least one of wired communications techniques such as USB, SATA, HSIC, SCSI, Firewire, PCI, PCIe, NVMe, UFS, SD, Secure Digital Input Output (SDIO), Universal Asynchronous Receiver Transmitter (UART), Serial Peripheral Interface (SPI), High Speed SPI (HS-SPI), RS232, Inter-integrated Circuit I2C), HS-I2C, Integrated-interchip Sound (I2S), Sony/Philips Digital Interface Format (S/PDIF), MMC, eMMC, and so on.

The user interface 1500 communicates with a user according to a control of the processor 1100. For example, the user interface 1500 may include user input interfaces such as a keyboard, a keypad, a button, a touch panel, a touch screen, a touch pad, a touch ball, a camera, a microphone, a gyroscope sensor, a vibration sensor, and so on. The user interface 1500 may further include user output interfaces such as a liquid crystal display (LCD), an Organic Light Emitting Diode (OLED) display device, an Active Matrix OLED (AMOLED) display device, an LED, a speaker, a motor, and so on.

The storage device 1300 may include a storage device 100 or 300 described with reference to FIGS. 1 to 24. In other words, the storage device 1300 adds status information to response data to transmit the status information and response data to the processor 1100.

The processor 1100 controls the storage device 1300 using the status information from the storage device 1300. For example, the processor 1100 may perform operations associated with the storage device 1300, such as power control, lifetime control, and so on.

While the inventive concept has been described with reference to exemplary embodiments thereof, it will be apparent to those skilled in the art that various changes and modifications may be made thereto without departing from the spirit and scope of the present inventive concept as defined by the claims.

1. An operation method of a storage device which includes a nonvolatile memory and a memory controller configured to control the nonvolatile memory, the operation method comprising:
receiving a request;
performing an operation corresponding to the received request;
generating response data corresponding to the performed operation, wherein the response data includes information on the performed operation; and
outputting the response data,
wherein status information is added to and output with the response data, wherein the status information includes information on a status of the storage device.

2. The operation method of claim 1, wherein collection of the status information is independent of the received request and the performed operation.

3. The operation method of claim 1, wherein the response data and the status information are transferred using a format of Universal Flash Storage Protocol Information Unit (UPIU).

4. The operation method of claim 3, wherein the status information is transferred using at least one field of 16^{th} to 31^{st} fields of a response UPIU.

5. The operation method of claim 3, wherein the status information is transferred using at least one field of 4^{th} to 7^{th}, 9^{th}, and 20^{th} to 31^{st} fields of a data out UPIU.

6. The operation method of claim 3, wherein the status information is transferred using at least one field of 20^{th} to 31^{st} fields of a ready to transfer UPIU.

7. The operation method of claim 3, wherein the status information is transferred using at least one field of 20^{th} to 31^{st} fields of a task management response UPIU.

8. The operation method of claim 3, wherein the status information is transferred using at least one field of 28^{th} to 31^{st} fields of a query response UPIU.

9. The operation method of claim 3, wherein the status information is transferred using at least one field of 16^{th}, 17^{th}, and 20^{th} to 27^{th} fields of a query response UPIU.

10. The operation method of claim 3, wherein the status information is transferred using at least one field of 16^{th} to 19^{th} and 24^{th} to 27^{th} fields of a query response UPIU.

11. The operation method of claim 3, wherein the status information is transferred using at least one field of 16^{th} to 22^{nd} and 24^{th} to 27^{th} fields of a query response UPIU.

12. The operation method of claim 3, wherein the status information is transferred using at least one field of 13^{th} to 27^{th} fields of a query response UPIU.

13. The operation method of claim 3, wherein the status information is transferred using at least one field of 12^{th} to 31^{th} fields of a NOP IN UPIU.

14. The operation method of claim 1, wherein the status information includes power-control information of the storage device.

15. The operation method of claim 14, wherein the status information further includes information on a time when the storage device enters a power-saving mode.

16. A storage device, comprising:
a nonvolatile memory; and
a memory controller configured to control the nonvolatile memory,
wherein the memory controller is further configured to collect status information including information on a status of the nonvolatile memory or the memory controller, and
wherein if an access request is received from an external device, the memory controller is configured to perform the access request, add the status information to response data including an execution result of the access request to generate first data, and output the first data to the external device.

17. A computing system, comprising:
a storage device; and
a host device configured to transmit a request to the storage device to control the storage device, write data at the storage device or read data from the storage device,
wherein the storage device is configured to collect status information including information on a status of the storage device, and
wherein the storage device is further configured to receive the request, perform the received request, add the status information to response data including an execution result of the received request to generate first data, and output the first data to the host device.

18. The computing system of claim 17, wherein the storage device is further configured to insert a first type of status information at a first location in a data format including the response data, and
wherein the host device is further configured to extract the first type of status information from the first location of the data format.

19. The computing system of claim 17, wherein the storage device is further configured to insert the status information and flag information indicating a type of the status information in a data format including the response data,
wherein the host device is further configured to extract the status information using the flag information of the status information, and
wherein the flag information is inserted at a predetermined location in the data format.

20. The computing system of claim 17, wherein the storage device is further configured to insert the status information and map information indicating a location and a type of the status information in a data format including the response data,
wherein the host device is further configured to extract the status information using the map information, and
wherein the map information is inserted at a predetermined location in the data format.

21-25. (canceled)
